(19) United States
(12) Patent Application Publication
(10) Pub. No.: US 2014/0360067 A1
(43) Pub. Date: Dec. 11, 2014

(54) METHOD AND APPARATUS FOR INFLUENCING GROCERY SHOPPERS TO MAKE HEALTHY FOOD PURCHASE DECISIONS

(71) Applicant: Gredo Kahng, Houston, TX (US)

(72) Inventor: Gredo Kahng, Houston, TX (US)

(21) Appl. No.: 14/465,628

(22) Filed: Aug. 21, 2014

Related U.S. Application Data
(63) Continuation-in-part of application No. 13/567,302, filed on Aug. 6, 2012.
Application No. 13/567,302 is a continuation-in-part of application No. 12/715,647, filed on Mar. 2, 2010, now abandoned.

(51) Int. Cl. G09F 7/10; G09F 7/14

(52) U.S. Cl. CPC G09F 7/10; G09F 7/14
USPC 40/618

(57) ABSTRACT

Disclosed is a structural element for displaying and enhancing the printed matter for display in the proximity of food items at the grocery store that associates the printed information with the food product by use of figures that represent the members of the family prominently displayed above the sign. It also relates the benefits and efficacy of consuming the food product and its components to the consumers age, physical condition and/or gender, in words, symbols or characterizations of people and color coding of the media. It also highlights the beneficial components of the food product without the need for reading the small print on product labels.

### CROSS-REFERENCE TO RELATED APPLICATIONS

This application is a continuation-in-part of U.S. patent application Ser. No. 13/567,302, filed Aug. 6, 2012, which is a continuation-in-part of U.S. patent application Ser. No. 12/715,647, filed Mar. 2, 2010 and claims the benefit of provisional application 61/156,747, filed Mar. 2, 2009.

### BACKGROUND

The present invention plants an intellectual impression in the minds of shoppers that buying a product that looks fresh and appealing is an expression of love to a specific person on their shopping list and is an intelligent, thoughtful and healthy choice. First, the sign structure uses figures at the top to draw attention to the shopper's family members that would benefit from the product and the reasons why. Then the nutrition sign firmly associates itself with the food on display with prominently located color picture of the food product and the product name in bold type. The figures also serve as a rapid indexing marker helping the buyer to find the components or efficacies of the food that specifically benefit the characterized loved one from a list of components and efficacies. Lastly, the sign reinforces the buyer's self image, and confidence with the statements of components and health benefits or efficacies. Self image because they are making an intellectual rather than an impulse decision. Confidence because they will be able to answer the inevitable question at the kitchen table “why are you feeding us this stuff instead of the food we are used to eat?” The buyer having a retort like “well this new food is good for relieving the joint pain that bothers you!” will have the buyer returning to the store and paying attention to the signs on the next shopping trip.

The statement of benefit or efficacy promotes purchase by relating the efficacy and component of the food product to the particular age group, physical condition or gender of the persons who will ultimately consume the food product. The preferred embodiment of the present invention relates all of this information to a grocery shopper at a glance to be effective through the use of photography, relating efficacy and component of the food product to the age, physical condition and gender of the consumer in succinct outline form and summarizing the nutritional components as well. The present invention also provides color sheets for the information that may have a positive effect on the ultimate consumer based on age, physical condition and/or gender and conveys additional information by use of characterization of people that may also be color coded and/or through information based color coding of the printed media.

### PRIOR ART

The following disclosures are found in the art of record.

The published patent application to Bateman (US2004/0023189) discloses a system and method for displaying nutritional information having a food product illustration and a partial or completely color coded background indicating the nutritional value of the food product. However Bateman lacks a food product photograph, lacks a printed name of the food product, also lacks efficacy and component of the food product related to the age, physical condition or gender of the ultimate consumer, and finally lacks characterizations of people according to age, physical condition or gender and color coding of the background.

The patent to Frankhauser (US Des. 323,680) discloses a sign for communicating food product information relating to leftovers that is divided into three sections vertically with pictures or illustrations in the top section, a list of leftovers names in the center section. Frankhauser, however, lacks displaying nutritional information, lacks having a color coded background indicating the nutritional value of the food product. Bateman also lacks a food product photograph and also lacks efficacy and component of the food product related to the age, physical condition or gender of the ultimate consumer, and finally lacks characterizations of people according to age, physical condition or gender and color coding of the background.

The published patent application to Gordon (US 2006/0263750) discloses printed matter communicating the nutritional value of a food product. However, Gordon lacks a food product photograph and printed name of the food product, also lacking is the efficacy and component of the food product related to the age, physical condition or gender of the ultimate consumer, there also are no characterizations of people according to age, physical condition or gender, nor does Gordon disclose color color coding of the printed media and a listing of beneficial nutritional components.

### BRIEF DESCRIPTION OF THE INVENTION

The present invention is a sign that is designed to assist a grocery store customer in the selection of food products that are healthy for themselves and the members of their family. It clearly associates the nutritional information with the correct food product with a picture of the food product and the food product name at the top. The benefits or efficacy and component of the food product is then stated in summary outline format, followed by specific benefits for consumers that are members of specific age groups, physical conditions such as pregnancy and/or gender. The shopper's attention is directed to specific statements of efficacy by the presence of characterizations of people in specific age groups, physical conditions such as pregnancy and/or gender on top of the sign and directed by color code to corresponding statements of interest. These statements are in outline form and are followed by a list of the primary components of the food product at the bottom of the sign. Further information regarding the properties, benefits, components or efficacy and component of the food product can be communicated by color coding of the characterizations or coloring of the media.

### BRIEF DESCRIPTION OF THE SEVERAL VIEWS OF THE DRAWING(S)

FIG. 1: Is a left side view of the preferred embodiment of the present invention.

FIG. 2: Is a front view of the preferred embodiment of the present invention on display.

FIG. 3: Is a Right side view of the preferred embodiment of the present invention with a figure installed in a socket along the tip edge.

FIG. 4: is a Right side view of the figure shown in FIG. 3.

FIG. 5: Is a front view of the preferred embodiment of the present invention in combination with the nutrition sign of the parent application.

FIG. 6: Is a block diagram of grocery shopping without the use of the present invention.

FIG. 7: Is a block diagram of grocery shopping with the use of the present invention.

FIG. 8 is a block diagram of the steps to assemble the preferred embodiment of the present invention.

### DETAILED DESCRIPTION OF THE INVENTION

Poor nutrition is rapidly becoming one of the major health problems in the civilized world affecting all people including babies, children, teenagers, men, women, pregnant women and seniors. Proper nutrition is one of the leading defenses against this insidious problem. There are many sources for nutritional information available to the public including, books, newspapers and the Internet. However, few shoppers carry such nutritional information with them when they shop in the grocery store. The present invention is a sign that summarizes nutritional information that is displayed in proximity of a food product, making it convenient for the consumer to make wise dietary choices in the grocery store.

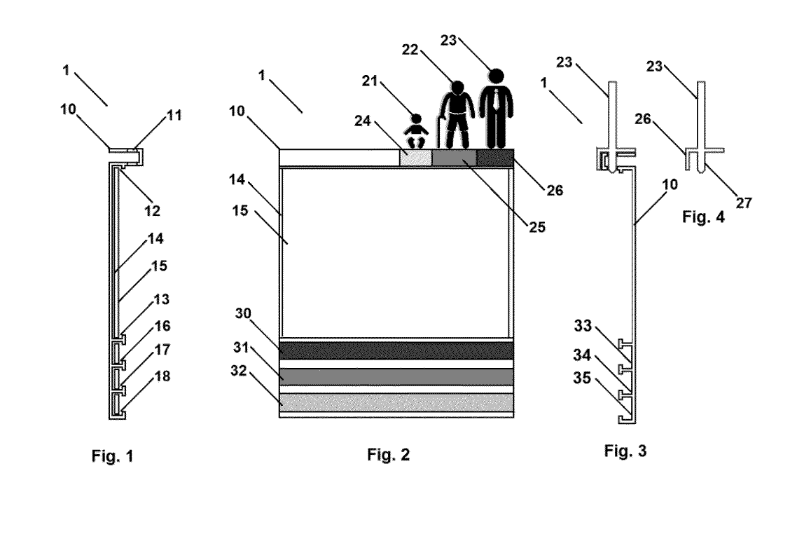

The instant invention is a nutrition sign structure 1 that enhances the effectiveness of the nutrition signs of the previous works of the inventor as disclosed in the aforementioned patent applications. Referring to FIGS. 1, 2, and 3, the framework 10 holds all of the kit components together. Socket 11 (also known as a slot) is for the mounting of human figures that call attention to the nutrition sign 15 (also known as product identifier sign) and symbolize the family members who would find the food advertised on the sign nutritious. Protrusions 12 and 13 as well as surface 14 (also known as the first region of the sign structure) hold a nutrition sign 15 in place. Channels 16, 17 and 18 hold colored sheet 30 of a first color colored sheet 31 of a second color and colored sheet 32 of a third color. Colored sheets 30, 31 and 32 (also known as nutritional banners) may be printed upon with nutritional information that is indexed by the color of the sheet it is printed upon. There may be more or fewer channels 33, 34 and 35 and corresponding colored sheets depending on the number of indexes that are required. FIGS. 21, 22 and 23 are the keys to the indexes 30, 31 and 32. A shopper looking for foods that are nutritious for their baby would find a nutrition sign 10 with a baby FIG. 21 on top. The baby FIG. 21 and or the figure base 24 are color coded to match the colored sheet 30. Similarly, the old man FIG. 22 has a figure base 25 that matches colored sheet 31. Also, the man FIG. 23 has a figure base 26 that matches colored sheet 32. Any number of figures with color coded figure bases may be included depending on the number of indexes desired for the particular nutritional information being conveyed including but not limited to a baby, a child, a boy, a girl, a teenager, a teen boy, a teen girl, a man, a woman, a pregnant woman, an elderly man and an elderly woman.

FIG. 4 shows man FIG. 23 with figure base 26 all or part of which may be color coded. Protrusion 27 slides into socket 11 to removably attach FIG. 23 to framework 10. FIGS. 21 and 22 also have protrusions 27 and like any additional figures that may be included are removably attached in the same manner. Other figures may include a boy (un-shown), male and female youth (un-shown), woman (un-shown), old woman (un-shown) and pregnant woman (un-shown).

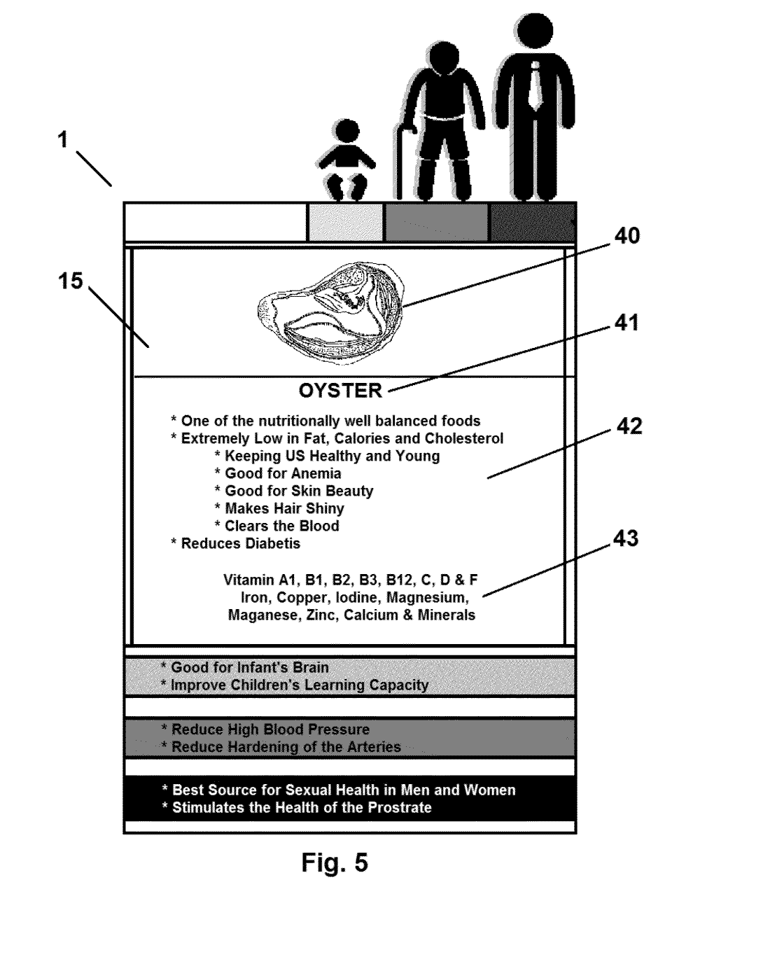

FIG. 5: Is a front view of the preferred embodiment of the present invention referred to as the nutrition sign structure 1 in combination with the nutrition sign 15, which contains picture 40, name 41, efficacy 42 and component 43 of the food product, of the parent application.

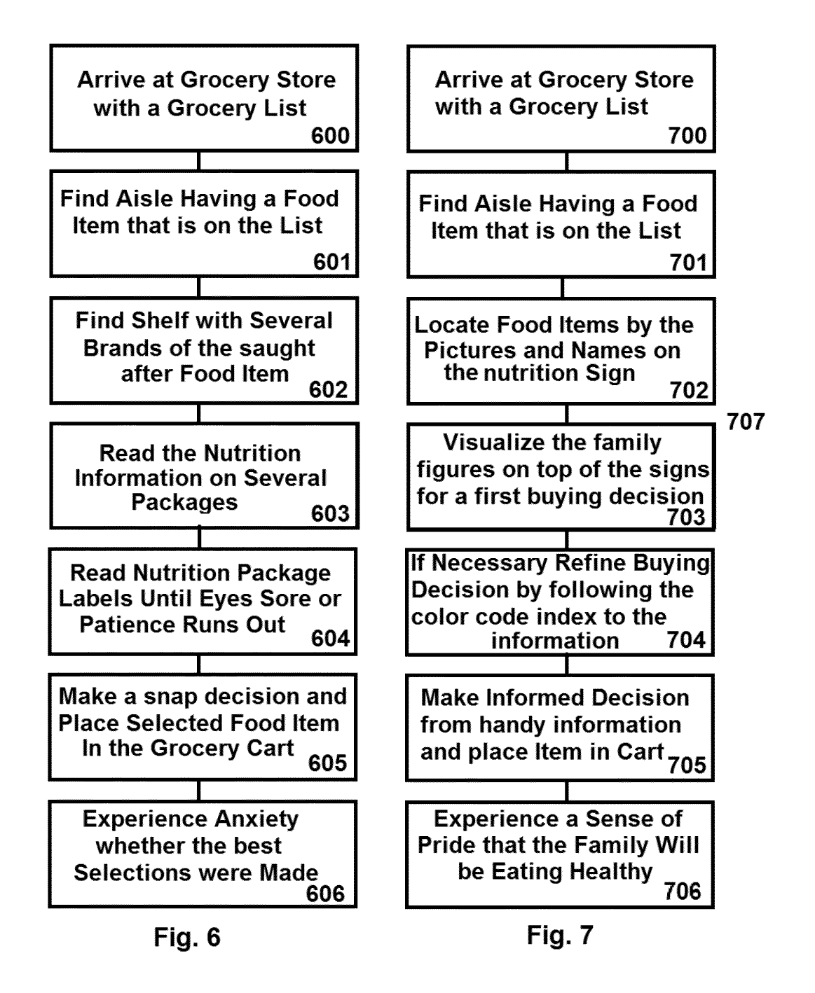

FIG. 6 shows the method of shopping for nutritional items without the nutritional sign and nutritional sign framework of the instant invention. The shopper arrives at the store with a grocery list 600. The shopper then finds an aisle having a food item that is on the shopping list 601. Next, the shopper finds a shelf or display with several brands of the sought after food item 602. Now the shopper has to pick up and read the nutritional information on several packages 603 until their eyes get sore or their patience runs out 604. Next, the shopper makes a snap decision and places the selected item in the grocery cart 605. Finally the shopper experiences anxiety whether the best selections were made 606.

The shopper using FIG. 7 has access to the nutrition sign structure and arrives at the grocery store with a grocery list 700. Then the shopper finds an aisle having a food item on the list 701. In Contrast to the shopper using the method of FIG. 5, the shopper with access to the Nutritional Sign Structure locates food items by the pictures and names on the nutrition sign 702. Then the shopper visualizes the family members in relation to the FIGS. 21, 22 and 23 on the top of the nutrition sign structure 10 for a first buying decision 603 (picking the food item associated with the nutrition sign structure 10 having figures that represent the buyer's family structure). Where the FIGS. 21, 22 and 23 do not give enough information the buyer uses the color code at the figure base 27 to find the detailed information on the colored sheets 30, 31 and 32 thus refining the buying decision by following the color code index to the information 704. The buyer can now make an informed decision from handy information and place selected item in the grocery cart 705. Lastly, the buyer experiences a sense of pride that the family will be eating healthy 706.

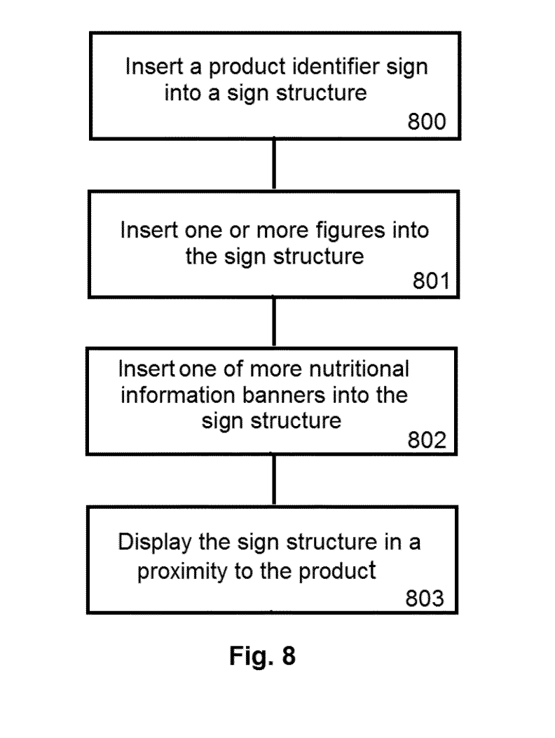

FIG. 8: Is a method of assembling a Nutrition sign structure 1 of the present invention including: inserting a product identifier sign into a sign structure 800, inserting one or more figures into the sign structure 801, the one or more figures extending from the sign structure, inserting one of more nutritional information banners into the sign structure 802, further displaying the sign structure in a proximity to the product 803.

I claim:

1. A method for advertising a product comprising:
inserting a product identifier sign into a sign structure, the product identifier sign providing a visual representation of the product being advertised, the product identifier sign being removably inserted into a first region of the sign structure;
inserting one or more figures into the sign structure, the one or more figures extending from the sign structure to provide a visual representation of one or more groups of people that can benefit from the product, each of the one or more figures depicted with a specified color code; and
inserting one of more nutritional information banners into the sign structure, the one or more nutritional information banners having a color identifier that matches a specified color code of the one or more figures, thereby relating a nutritional benefit to a specific one of the one or more groups of people.

2. The method of claim 1, further comprising displaying the sign structure in a proximity to the product.

3. The method of claim 1, wherein the one or more nutritional information banners are displayed below the product identifier sign.

4. The method of claim 1, wherein the one or more figures are removably attached to a top portion of the sign structure and extend above the top portion of the sign structure.

5. The method of claim 1, wherein the one or more figures are selected from the group consisting of a baby, a child, a boy, a girl, a teenager, a teen boy, a teen girl, a man, a woman, a pregnant woman, an elderly man and an elderly woman.

6. The method of claim 1, wherein the sign structure includes a plurality of slots to receive each of the one or more nutritional information banners.

7. The method of claim 1, wherein the specified color code of the one or more figures is provided by one of coloring the figure with the specified color code and providing a figure base having the specified color code.

8. A method for advertising a product comprising:
inserting a product identifier sign into a central region of a sign structure, the product identifier sign providing a visual representation of the product being advertised, the product identifier sign being removably inserted into the central region of the sign structure;
inserting one or more figures into the sign structure, the one or more figures extending from a top portion of the sign structure to provide a visual representation of one or more groups of people that can benefit from the product, each of the one or more figures depicted with a specified color code; and
inserting one of more nutritional information banners into one or more of a plurality of lower regions, below the central region, of the sign structure, the one or more nutritional information banners having a color identifier that matches a specified color code of the one or more figures, thereby relating a nutritional benefit to a specific one of the one or more groups of people.

9. The method of claim 8, further comprising displaying the sign structure in a proximity to the product.

10. The method of claim 8, wherein the one or more figures are selected from the group consisting of a baby, a child, a boy, a girl, a teenager, a teen boy, a teen girl, a man, a woman, a pregnant woman, an elderly man and an elderly woman.

11. The method of claim 8, wherein the specified color code of the one or more figures is provided by one of coloring the figure with the specified color code and or providing a figure base having the specified color code.

12. An advertisement sign comprising:
a first channel receiving a product identifier sign into a central region of a sign structure, the product identifier sign providing a visual representation of a product being advertised, the product identifier sign, which contains name, picture, efficacies and component of a product, being removably inserted into the first channel of the sign structure;
one or more figures insertable into the sign structure, the one or more figures extending from a top portion of the sign structure to provide a visual representation of one or more groups of people that can benefit from the product, each of the one or more figures depicted with a specified color code; and
one of more nutritional information channels receiving one or more nutritional information banners, the one or more nutritional information banners having a color identifier that matches a specified color code of the one or more figures, thereby relating a nutritional benefit to a specific one of the one or more groups of people.

13. The advertisement sign of claim 12, wherein the one or more nutritional information banners are displayed below the product identifier sign.

14. The advertisement sign of claim 12, wherein the one or more figures are removably attached to a top portion of the sign structure and extend above the top portion of the sign structure.

15. The advertisement sign of claim 12, wherein the one or more figures are selected from the group consisting of a baby, a child, a boy, a girl, a teenager, a teen boy, a teen girl, a man, a woman, a pregnant woman, an elderly man and an elderly woman.

16. The advertisement sign of claim 12, further comprising a figure base having the specified color code of the one or more figures.

17. The advertisement sign of claim 12, further comprising a slot disposed in the top portion of the sign structure, the slot receiving a protrusion disposed on each of the one or more figures, the slot and the protrusion allowing each of the one or more figures to be disposed at any location along the top portion of the sign structure.
